(19) United States
(12) Patent Application Publication
(10) Pub. No.: US 2014/0213111 A1
(43) Pub. Date: Jul. 31, 2014

(54) CONNECTOR WITH EXPANDABLE CHIP

(71) Applicant: Nai-Chien CHANG, New Taipei City (TW)

(72) Inventor: Nai-Chien CHANG, New Taipei City (TW)

(21) Appl. No.: 14/155,946

(22) Filed: Jan. 15, 2014

(30) Foreign Application Priority Data
Jan. 31, 2013 (TW) 102202172

(51) Int. Cl. H01R 13/514

(52) U.S. Cl. CPC H01R 13/514
USPC 439/620.15

(57) ABSTRACT

A connector with an expandable chip includes a base, a plurality of conductive terminals, and a plurality of connection terminals. The base has a front terminal surface and a rear terminal surface. The front terminal surface is extended forward to form a tongue portion, and the rear terminal surface is defined inward to form a slot. The conductive terminals are correspondingly arranged in upper terminal slots of the tongue portion, and one terminal of each conductive terminal is exposed from the slot. The connection terminals are correspondingly arranged in the lower terminal slots of the tongue portion, and one terminal of each connection terminal is exposed from the slot. When a circuit board with a chip is inserted into the slot, the circuit board can be simultaneously electrically connected to the conductive terminals and the connection terminals, thus providing the function of the chip mounted on the circuit board.

### BACKGROUND

1. Technical Field

The present disclosure relates generally to a connector, and more particularly to a connector with an expandable chip.

2. Description of Related Art

In general, each of various electronic devices has one or more connector to transmit data or supply power to the electronic device. Also, the connector is usually used to cooperate with corresponding chips. For example, if the USB connector is used, an integrated circuit with functions of coding and decoding USB is necessary to be mount on the mother board of the electronic device to process signals of the USB connector. Also, other specific-function chips, such as the repeater IC or the hub IC can be used to upgrade performance of the connector.

Because the volume of each of various electronic devices, such as laptop computers or notebook computers is getting smaller and the area of the mother board thereof is reduced recent years, many new-type connectors provide the built-in chips in the shell thereof. Accordingly, the occupied space of mounting the original chips and connecting circuit wires on the mother board can be saved.

However, the available space in a small connector is limited so that the large-size chip cannot be directly built inside the connector. In general, an extra circuit board is added in the shell of the connector and the specific-function chip is mounted on the circuit board to implement the connector with the chip. However, the height of the connector is greater so that it is difficult to apply this kind of connector to the ultra-book computers or laptop computers.

### SUMMARY

An object of the present disclosure is to provide a connector with an expandable chip so that different circuit boards with specific-function chips can be inserted into the connector to change functions of the connector with the expandable chip according to practical requirements of the user.

In order to achieve the above object, a connector with an expandable chip is configured to electrically connect to a mother board of an external electronic apparatus. The connector includes a base, a plurality of conductive terminals, and a plurality of connection terminals. The base has a front terminal surface and a rear terminal surface, the front terminal surface is extended forward to form a tongue portion, and the rear terminal surface is defined inward to form a slot. The tongue portion has a plurality of upper terminal slots communicated to the slot in the tongue portion, and the slot has a plurality of lower terminal slots communicated to a bottom of the slot. The conductive terminals correspondingly are arranged in the upper terminal slots, and one terminal of each conductive terminal is exposed from the slot. The connection terminals are correspondingly arranged in the lower terminal slots, and one terminal of each connection terminal is exposed from the slot. When a circuit board with a chip is inserted into the slot, the circuit board can be simultaneously electrically connected to the conductive terminals and the connection terminals, thus providing the function of the chip mounted on the circuit board.

Comparing to the related art, different specific-function chips are mounted on different circuit boards, and the different circuit boards can be replaced according to practical requirements of the user so that the connector with the expandable chip can provide different functions. That is, the circuit board is only replaced and another circuit board with a new function is inserted into the connector without replacing the connector so that the original connector can provide the new function for the user.

It is to be understood that both the foregoing general description and the following detailed description are exemplary, and are intended to provide further explanation of the present disclosure as claimed. Other advantages and features of the present disclosure will be apparent from the following description, drawings and claims.

### BRIEF DESCRIPTION OF DRAWINGS

The features of the present disclosure believed to be novel are set forth with particularity in the appended claims. The present disclosure itself, however, may be best understood by reference to the following detailed description of the present disclosure, which describes an exemplary embodiment of the present disclosure, taken in conjunction with the accompanying drawings, in which:

FIG. 1 is a perspective exploded view of a connector with an expandable chip according to a first embodiment of the present disclosure;

FIG. 2 is a perspective assembled view of the connector with the expandable chip according to the first embodiment of the present disclosure;

FIG. 3 is a rear view of the connector with the expandable chip according to the first embodiment of the present disclosure;

FIG. 4 is a cross-sectional view of the connector with the expandable chip according to the first embodiment of the present disclosure;

FIG. 5 is another cross-sectional view of the connector with the expandable chip according to the first embodiment of the present disclosure;

FIG. 6 is a cross-sectional view of the connector with the expandable chip according to a second embodiment of the present disclosure;

FIG. 7 is a cross-sectional view of the connector with the expandable chip according to a third embodiment of the present disclosure;

FIG. 8 is a cross-sectional view of the connector with the expandable chip according to a fourth embodiment of the present disclosure; and

FIG. 9 is a cross-sectional view of the connector with the expandable chip according to a fifth embodiment of the present disclosure.

### DETAILED DESCRIPTION

Reference will now be made to the drawing figures to describe the present invention in detail.

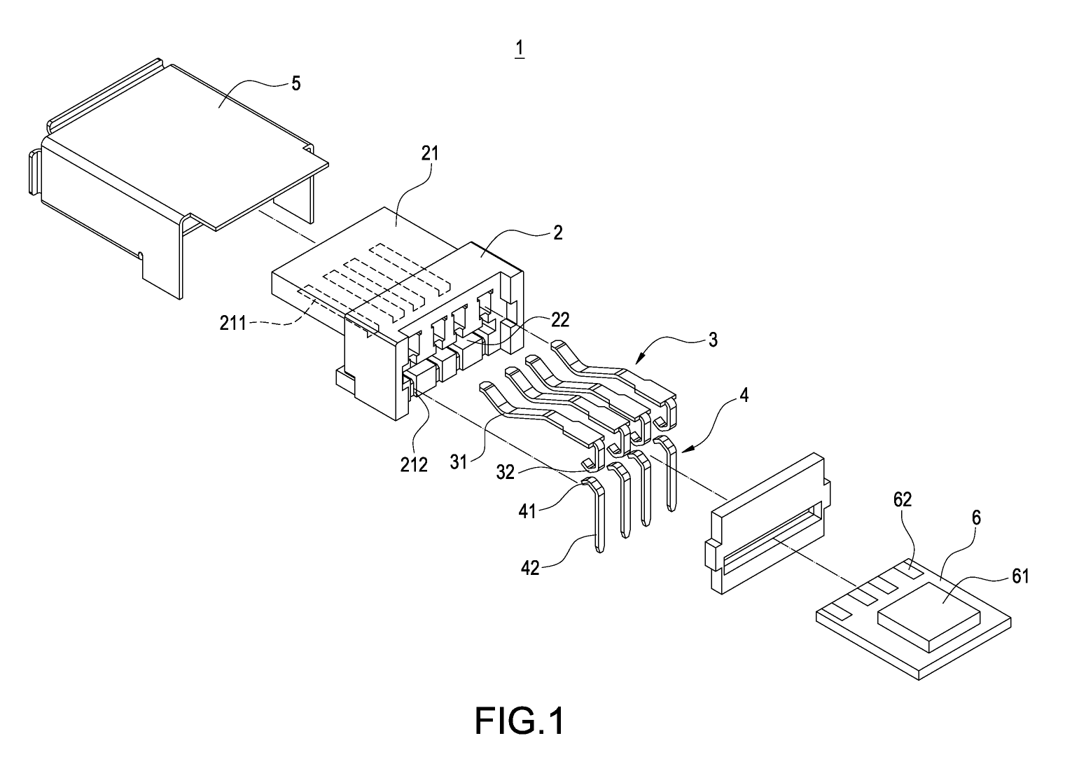

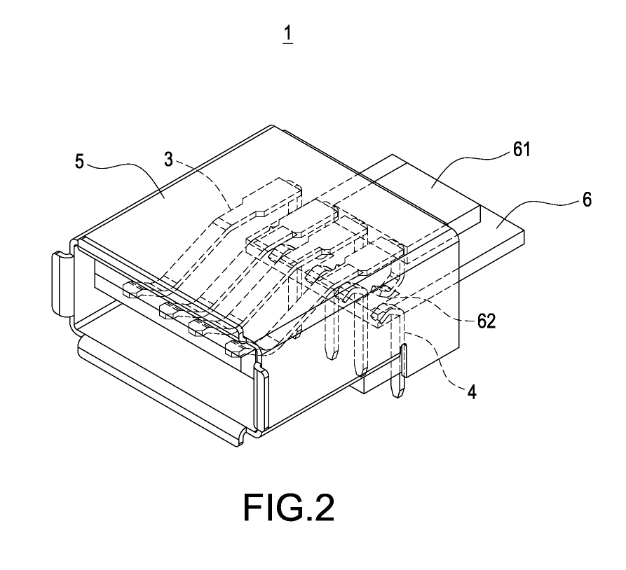

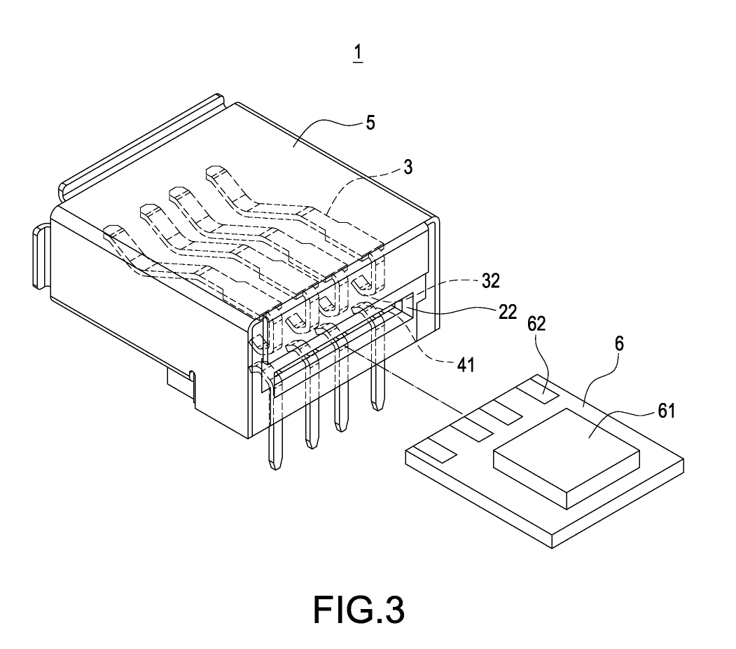

Reference is made to FIG. 1, FIG. 2, and FIG. 3 which are a perspective exploded view, a perspective assembled view, and a rear view of a connector with an expandable chip according to a first embodiment of the present disclosure, respectively. The present disclosure discloses a connector with an expandable chip (referred to as a “connector 1” hereinafter). The connector 1 mainly includes a base 2, a plurality of conductive terminals 3, a plurality of connection terminals 4, and a metal shell 5.

The base 2 is substantially is an insulating plastic part. The base 2 has a front terminal surface and a rear terminal surface. The front terminal surface is extended forward to form a tongue portion 21, and the rear terminal surface is defined inward to form a slot 22. The tongue portion 2 has a plurality of upper terminal slots 211 communicated to the slot 22, and the number of the upper terminal slots 211 is corresponding to the number of the conductive terminals 3. The conductive terminals 3 are inserted into the upper terminal slots 211, and one terminal of each conductive terminal 3 is exposed from the slot 22 through the upper terminal slot 211.

The slot 22 has a plurality of lower terminal slots 212 communicated to a bottom of the slot 22, and the number of the lower terminal slots 212 is corresponding to the number of the connection terminals 4. The connection terminals 4 are inserted into the lower terminal slots 212, and one terminal of each connection terminal is exposed from the slot 22. When a circuit board 6 is inserted into the slot 22, the circuit board 6 can be simultaneously electrically connected to the conductive terminals 3 and the connection terminals 4 which are exposed from the slot 22. Accordingly, the conductive terminals 3 and the connection terminals 4 can electrically conducted to each other through circuit wires on the circuit board 6.

In this embodiment, the number of the conductive terminals 3 and the number of the connection terminals 4 are both four. Correspondingly, the number of the upper terminal slots 211 and the number of the lower terminal slots 212 are both four. The connector 1 is a USB 2.0 connector.

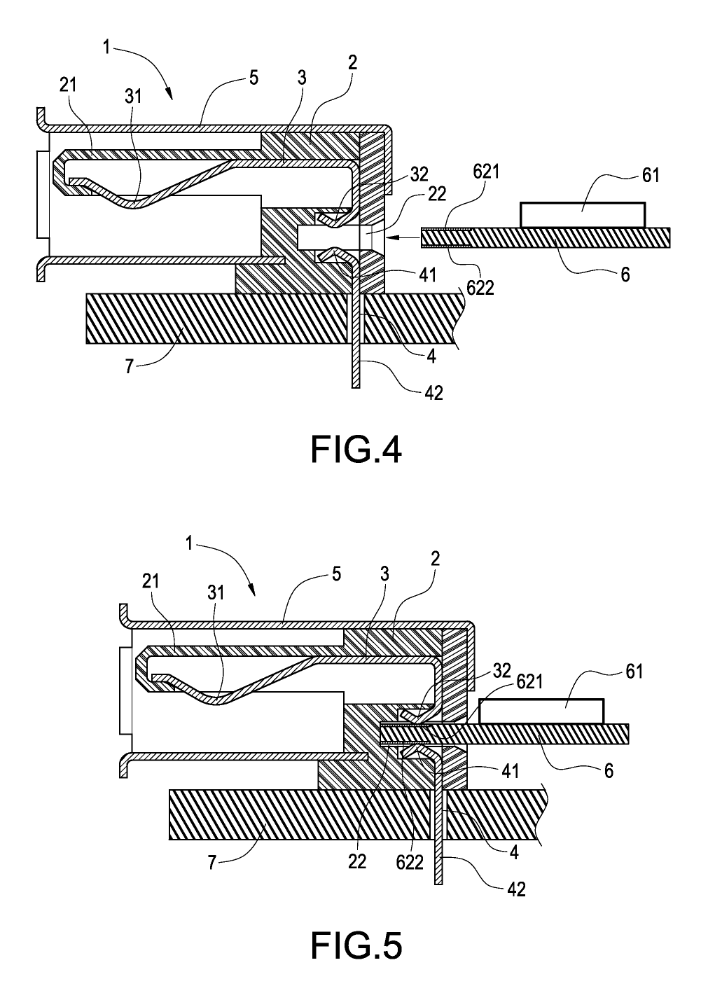

Each of the conductive terminals 3 has a first conductive portion 31 and a second conductive portion 32. The first conductive portions 31 are exposed from the tongue portion 21 to electrically connect to an external male connector (not shown). The second conductive portions 32 are extended downward and bent, and exposed from the slot 22 so as to electrically connect to the circuit board 6. Each of the connection terminals 4 has a first connection portion 41 and a second connection portion 42. The first connection portions 41 are exposed from the slot 22 to electrically connect to the circuit board 6. The second connection portions 42 are extended toward a bottom of the base 2 and protruded through the bottom of the base 2 so as to electrically connect to a mother board (as shown in FIG. 4) of an external electronic apparatus.

In this embodiment, the electrical connection between the conductive terminals 3 and the connection terminals 4 is made through circuit wires on the circuit board 6. Hence, the conductive terminals 3 are electrically disconnected to the connection terminals 4 before the circuit board 6 is inserted into the slot 22 so that the connector 1 cannot provide normal operations.

The shape and size of the circuit board 6 are corresponding to those of the slot 22 so that the circuit board 6 is exactly inserted into the base 2 through the slot 22. The circuit board 6 has a chip 61 thereon and the chip 61 provides functions which can be supported by the connector 1. In addition, the circuit board 6 has a plurality of gold fingers 62 electrically connected to the chip 61 thereon.

As shown in FIG. 3, when the circuit board 6 is inserted into the slot 22, the gold fingers 62 are electrically connected to the conductive terminals 3 and the connection terminals 4. Accordingly, the conductive terminals 3 are connected to the chip 61 through the circuit board 6 to receive signals. The received signals are processed by the chip 61, and the processed signals are transmitted from the circuit board 6 to the connection terminals 4. That is, all signals received by the connector 1 can be processed by the chip 61 of the circuit board 6, and then processed signals are outputted.

For example, the chip 61 can be a repeater integrated circuit (IC). When the connector 1 receives the signal outputted from the mother board 7 through the connection terminals 4, the repeater IC of the circuit board 6 is provided to amplify the signal, and then output the amplified signal through the conductive terminals 3, thus ensuring the signal strength. According to practical requirements of the user, the chip 61 can be replaced in different specific functions, such as the signal encryption/decryption IC, the surge protection IC, the memory, or the microprocessor. However, the embodiments are only exemplified but are not intended to limit the scope of the disclosure.

Moreover, if the connector 1 is a stacked connector, the chip 61 can be a hub IC. For example, the number of the conductive terminals 3 is eight if the connector 1 is the stacked connector with two stacked USB connectors. When the conductive terminals 3 are connected to the hub IC on the circuit board 6, the signals are processed by the hub IC to output the processed signals through half of the connection terminals 4, thus saving number of the connection terminals 4 and simplifying the circuit layout on the mother board 7.

The metal shell 5 is provided to cover the base 2, the conductive terminals 3, and the connection terminals 4. Especially, when the circuit board 6 is inserted into the slot 22 as shown in FIG. 2, a part of the circuit board 6 is exposed from the base 2 that is the circuit board 6 is not completely inserted into the slot 22. Accordingly, the entire volume of the base 2 with the slot 22 does not become bigger and the circuit board 6 is conveniently and easily replaced. In this embodiment, the circuit board 6 is a flexible circuit board, but not limited.

Reference is made to FIG. 1, FIG. 2, and FIG. 3 which are a cross-sectional view and another cross-sectional view of the connector with the expandable chip according to the first embodiment of the present disclosure;, respectively. The circuit board 6 has an upper layer and a lower layer, and a plurality of upper layer gold fingers 621 are arranged on the upper layer and a plurality of lower layer gold fingers 622 are arranged on the lower layer. The upper layer gold fingers 621 and the lower layer gold fingers 622 are electrically connected to the chip 61 through the circuit board 6. As shown in FIG. 5, the number and arrangement of the upper layer gold fingers 621 are corresponding to those of the second conductive portions 32; the number and arrangement of the lower layer gold fingers 622 are corresponding to those of the first connection portions 41. Accordingly, the conductive terminals 3 are electrically connected to the circuit board 6 through the second conductive portions 32 and the upper layer gold fingers 621, and the connection terminals 4 are electrically connected to the circuit board 6 through the first connection portions 41 and the lower layer gold fingers 622 when the circuit board 6 is inserted into the slot 22.

As shown in FIG. 4, each of the second conductive portions 32 and each of the first connection portions 41 can be bent inward to form an arc-shaped structure, respectively, thus enlarging contact areas with the gold fingers 62 and increasing contact stability.

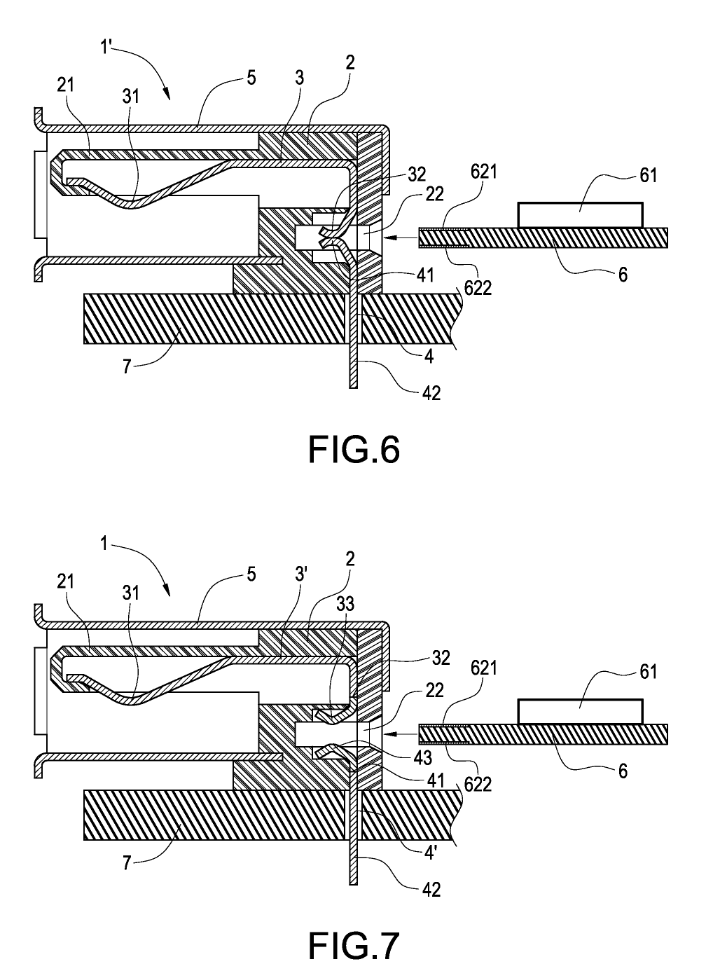

Reference is made to FIG. 6 which is a cross-sectional view of the connector with the expandable chip according to a second embodiment of the present disclosure. In the above-mentioned embodiment, the second conductive portions 32 and the first connection portions 41 are separated (as shown in FIG. 4) so that the second conductive portions 32 are disconnected to the first connection portions 41 when the circuit board 6 is drawn out the slot 22 so that the connector 1 cannot provide normal operations. In this embodiment, another connector 1′ is disclosed. The second conductive portions 32 of the conductive terminals 3 are directly touched to the first connection portions 41 of the connection terminals 4. Accordingly, the connector 1′ can provide normal operations to be a connector without chip function even though the circuit board 6 is not inserted into the slot 22.

In addition, the front edge of the circuit board 6 would press the second conductive portions 32 and the first connection portions 41 when the circuit board 6 is inserted into the slot 22 so that the second conductive portions 32 and the first connection portions 41 are separated to disconnect electrical connections between the gold fingers 62 on the circuit board 6. Accordingly, the connector 1′ can be regarded as a connector having functions of the chip 61.

Reference is made to FIG. 7 which is a cross-sectional view of the connector with the expandable chip according to a third embodiment of the present disclosure. In the above-mentioned embodiment, each of the second conductive portions 32 and each of the first connection portions 41 are bent inward to form an arc-shaped structure, respectively, thus enlarging contact areas with the gold fingers 62 and increasing contact stability. In this embodiment, another conductive terminal 3′ and another connection terminal 4′ are disclosed. The conductive terminal 3′ is welded to an arc-shaped elastic piece 33 through the second conductive portion 32; the connection terminal 4′ is welded to an arc-shaped elastic piece 43 through the first connection portions 41. Therefore, the original terminal can be divided into the conductive terminal 3 and the connection terminal 4 when the connector 1, 1′ is manufactured. Also, the two bent and arc-shaped elastic pieces 33, 43 are welded to the second conductive portion 32 and the first connection portion 41, respectively, thus forming the conductive terminal 3′ and the connection terminal 4′ in this embodiment to effectively increase speed of manufacturing the connector 1, 1′.

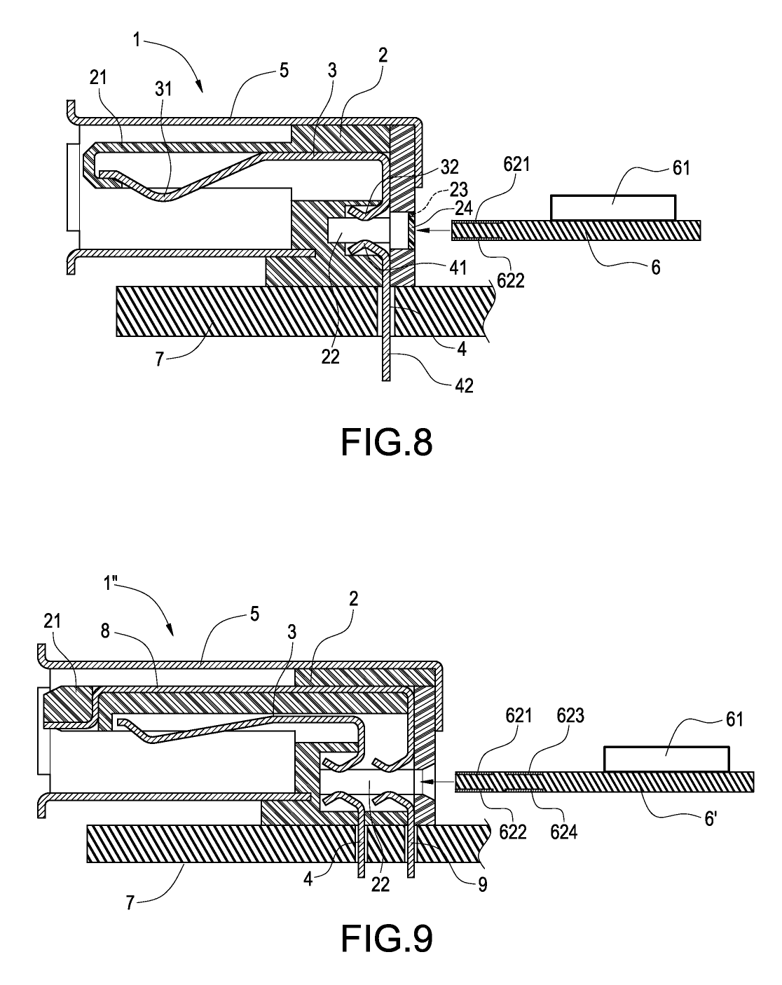

Reference is made to FIG. 8 which is a cross-sectional view of the connector with the expandable chip according to a fourth embodiment of the present disclosure. The base 2 of the connector 1 further has a pivot 23 disposed on the rear terminal surface thereof, and a barrier 24 disposed at an exit position of the slot 22. The barrier 24 is pivotally engaged with the exit position of the slot 22 through the pivot 23. The barrier 24 is pushed into the slot 22 by the circuit board 6 when the circuit board 6 is inserted into the slot 22; the barrier 24 is provided to block the exit position of the slot 22 when the circuit board 6 is drawn away from the slot 22, thus preventing damage to the connector 1 from invasion of extraneous matters.

Reference is made to FIG. 9 which is a cross-sectional view of the connector with the expandable chip according to a fifth embodiment of the present disclosure. The present disclosure discloses further another connector 1″, and the connector 1″ further has a plurality of second conductive terminals 8 and a plurality of second connection terminal 9. The second conductive terminals 8 are correspondingly arranged in the upper terminal slots 211 of the tongue portion 21, and the second connection terminals 9 are correspondingly arranged in the lower terminal slots 212. Also, one terminal of each second conductive terminal 8 and one terminal of each second connection terminal 9 are exposed from the slot 22.

In this embodiment, the number of the upper terminal slots 211 and the number of the lower terminal slots 212 are equal to nine, respectively. The sum of the number of the conductive terminals 3 and the number of the second conductive terminals 8 is nine, and the sum of the connection terminals 4 and the number of the second connection terminals 9 is nine. The connector 1″ is a USB 3.0 connector.

In this embodiment, the shape and size of the slot 22 on the connector 1″ are corresponding to those of another circuit board 6′. The circuit board 6′ has an upper layer and a lower layer, and a plurality of upper layer gold fingers 621 and a plurality of second upper layer gold fingers 623 are arranged on the upper layer and a plurality of lower layer gold fingers 622 and a plurality of second lower layer gold fingers 624 are arranged on the lower layer. The conductive terminals 3 are electrically connected to the connection terminals 4 through the upper layer gold fingers 621 and the lower layer gold fingers 622; the second conductive terminals 8 are electrically connected to the second connection terminals 9 through the second upper layer gold fingers 623 and the second lower layer gold fingers 624 when the circuit board 6′ is inserted into the slot 22 of the connector 1″. Therefore, the connector 1″ can be regarded as a connector having functions of the chip 61 mounted on the circuit board 6′ when the circuit board 6″ is inserted into the connector 1″.

Although the present disclosure has been described with reference to the preferred embodiment thereof, it will be understood that the present disclosure is not limited to the details thereof. Various substitutions and modifications have been suggested in the foregoing description, and others will occur to those of ordinary skill in the art. Therefore, all such substitutions and modifications are intended to be embraced within the scope of the present disclosure as defined in the appended claims.

What is claimed is:

1. A connector with an expandable chip configured to electrically connect to a mother board of an external electronic apparatus, the connector comprising:
a base having a front terminal surface and a rear terminal surface, the front terminal surface extended forward to form a tongue portion, and the rear terminal surface defined inward to form a slot; the tongue portion having a plurality of upper terminal slots communicated to the slot in the tongue portion, and the slot having a plurality of lower terminal slots communicated to a bottom of the slot;
a plurality of conductive terminals correspondingly arranged in the upper terminal slots, and one terminal of each conductive terminal exposed from the slot; and
a plurality of connection terminals correspondingly arranged in the lower terminal slots, and one terminal of each connection terminal exposed from the slot.

2. The connector with the expandable chip in claim 1, wherein each conductive terminal has a first conductive portion and a second conductive portion; the first conductive portions are exposed from the tongue portion, and the second conductive portions are extended downward, bent, and exposed from the slot; each connection terminal has a first connection portion and a second connection portion; the first connection portions are exposed from the slot, and the second connection portions are extended toward a bottom of the base and protruded through the bottom of the base to electrically connect to the mother board; wherein each second conductive portion and each first connection portion are bent inward to form an arc-shaped structure.

3. The connector with the expandable chip in claim 1, wherein the shape and size of the slot is corresponding to the shape and size of an external circuit board so that the external circuit board is inserted into the slot.

4. The connector with the expandable chip in claim 3, wherein the circuit board has a chip thereon, and the circuit board has an upper layer and a lower layer; a plurality of upper layer gold fingers electrically connected to the chip are arranged on the upper layer, and a plurality of lower layer gold fingers electrically connected to the chip are arranged on the lower layer; wherein the number and arrangement of the upper layer gold fingers are corresponding to the number and arrangement of the second conductive portions, and the number and arrangement of the lower layer gold fingers are corresponding to the number and arrangement of the first conductive portions.

5. The connector with the expandable chip in claim 4, wherein the chip is a repeater integrated circuit (IC).

6. The connector with the expandable chip in claim 2, wherein the base has a pivot and a barrier are disposed on the rear terminal surface thereof, and the barrier is pivotally engaged with an exit position of the slot through the pivot.

7. A connector with an expandable chip configured to electrically connect to a mother board of an external electronic apparatus, the connector comprising:
a base having a front terminal surface and a rear terminal surface, the front terminal surface extended forward to form a tongue portion, and the rear terminal surface defined inward to form a slot; the tongue portion having a plurality of upper terminal slots communicated to the slot in the tongue portion, and the slot having a plurality of lower terminal slots communicated to a bottom of the slot;
a plurality of conductive terminals correspondingly arranged in the upper terminal slots, and one terminal of each conductive terminal exposed from the slot;
a plurality of connection terminals correspondingly arranged in the lower terminal slots, and one terminal of each connection terminal exposed from the slot; and
a circuit board having a chip thereon, the shape and size of the circuit board corresponding to the shape and size of the slot; the circuit board having an upper layer and a lower layer; wherein a plurality of upper layer gold fingers electrically connected to the chip are arranged on the upper layer, and a plurality of lower layer gold fingers electrically connected to the chip are arranged on the lower layer.

8. The connector with the expandable chip in claim 7, wherein each conductive terminal has a first conductive portion and a second conductive portion; the first conductive portions are exposed from the tongue portion, and the second conductive portions are extended downward, bent, and exposed from the slot; each connection terminal has a first connection portion and a second connection portion; the first connection portions are exposed from the slot, and the second connection portions are extended toward a bottom of the base and protruded through the bottom of the base to electrically connect to the mother board; wherein each second conductive portion and each first connection portion are bent inward to form an arc-shaped structure.

9. The connector with the expandable chip in claim 8, wherein the chip is a repeater integrated circuit (IC).

10. The connector with the expandable chip in claim 8, wherein the base has a pivot and a barrier are disposed on the rear terminal surface thereof, and the barrier is pivotally engaged with an exit position of the slot through the pivot.
